(19) United States
(12) Patent Application Publication
(10) Pub. No.: US 2026/0129726 A1
(43) Pub. Date: May 7, 2026

(54) LOAD CONTROL DEVICE FOR A LIGHT-EMITTING DIODE LIGHT SOURCE

(71) Applicant: Lutron Technology Company LLC, Coopersburg, PA (US)

(72) Inventors: Robert D. Stevens, Jr., Emmaus, PA (US); Matthew R. Zartman, Bethlehem, PA (US)

(73) Assignee: Lutron Technology Company LLC, Coopersburg, PA (US)

(21) Appl. No.: 19/260,734

(22) Filed: Jul. 7, 2025

Related U.S. Application Data
(63) Continuation of application No. 18/663,255, filed on May 14, 2024, now Pat. No. 12,356,519.
Application No. 18/663,255 is a continuation of application No. 18/296,407, filed on Apr. 6, 2023, now Pat. No. 12,022,582.
Application No. 18/296,407 is a continuation of application No. 17/394,073, filed on Aug. 4, 2021, now Pat. No. 11,653,427.
Application No. 17/394,073 is a continuation of application No. 16/808,098, filed on Mar. 3, 2020, now Pat. No. 11,109,456.
Application No. 16/808,098 is a continuation of application No. 16/446,601, filed on Jun. 19, 2019, now Pat. No. 10,609,777.
Application No. 16/446,601 is a continuation of application No. 16/127,163, filed on Sep. 10, 2018, now Pat. No. 10,356,868.
Application No. 16/127,163 is a continuation of application No. 15/583,425, filed on May 1, 2017, now Pat. No. 10,104,735.
Application No. 15/583,425 is a continuation of application No. 15/186,254, filed on Jun. 17, 2016, now Pat. No. 9,655,180.
(60) Provisional application No. 62/182,110, filed on Jun. 19, 2015.

(51) Int. Cl. H05B 45/10; H05B 45/14; H05B 45/327; H05B 45/3725; H05B 45/375; H05B 45/38; H05B 45/39; H05B 45/395; H05B 47/16; H05B 47/19

(52) U.S. Cl. CPC H05B 45/10; H05B 45/14; H05B 45/327; H05B 45/3725; H05B 45/375; H05B 45/38; H05B 45/39; H05B 45/395; H05B 47/16; H05B 47/19

(57) ABSTRACT

A load control device for an electrical load is configured to operate in a normal mode and a burst mode to adjust the amount of power delivered to the electrical load. The load control device comprises a control circuit that operates in the normal mode to regulate an average magnitude of a load current conducted through the load between a maximum rated current and a minimum rated current. During the normal mode, the control circuit controls the operating period of a load regulation circuit between a high-end operating period and a low-end operating period. The control circuit operates in the burst mode to regulate the average magnitude of the load current below the minimum rated current. During the burst mode, the control circuit adjusts the low-end operating period to be less than or equal to a minimum on time of the load regulation circuit.

### CROSS-REFERENCE TO RELATED APPLICATIONS

This application is a continuation of U.S. patent application Ser. No. 18/663,255 filed May 14, 2024; which is a continuation of U.S. patent application Ser. No. 18/296,407, filed Apr. 6, 2023, now U.S. Pat. No. 12,022,582, issued Jun. 25, 2024; which is a continuation of U.S. patent application Ser. No. 17/394,073 filed Aug. 4, 2021, now U.S. Pat. No. 11,653,427, issued May 16, 2023; which is a continuation of U.S. patent application Ser. No. 16/808,098, filed Mar. 3, 2020, now U.S. Pat. No. 11,109,456, issued Aug. 31, 2021; which is a continuation of U.S. patent application Ser. No. 16/446,601, filed Jun. 19, 2019, now U.S. Pat. No. 10,609,777, issued Mar. 31, 2020; which is a continuation of U.S. patent application Ser. No. 16/127,163, filed Sep. 10, 2018, now U.S. Pat. No. 10,356,868, issued Jul. 16, 2019; which is a continuation of U.S. patent application Ser. No. 15/583,425, filed May 1, 2017, now U.S. Pat. No. 10,104,735, issued Oct. 16, 2018; which is a continuation of U.S. patent application Ser. No. 15/186,254, filed Jun. 17, 2016, now U.S. Pat. No. 9,655,180, issued May 16, 2017; which claims the benefit of Provisional U.S. Patent Application No. 62/182,110, filed Jun. 19, 2015, the disclosures of all of which are incorporated herein by reference in their entireties.

### BACKGROUND

Light-emitting diode (LED) light sources (i.e., LED light engines) are often used in place of or as replacements for conventional incandescent, fluorescent, or halogen lamps, and the like. LED light sources may comprise a plurality of light-emitting diodes mounted on a single structure and provided in a suitable housing. LED light sources are typically more efficient and provide longer operational lives as compared to incandescent, fluorescent, and halogen lamps. In order to illuminate properly, an LED driver control device (i.e., an LED driver) must be coupled between an alternating-current (AC) source and the LED light source for regulating the power supplied to the LED light source. The LED driver may regulate either the voltage provided to the LED light source to a particular value, the current supplied to the LED light source to a specific peak current value, or both the current and voltage.

LED light sources are typically rated to be driven via one of two different control techniques: a current load control technique or a voltage load control technique. An LED light source that is rated for the current load control technique is also characterized by a rated current (e.g., approximately 350 milliamps) to which the peak magnitude of the current through the LED light source should be regulated to ensure that the LED light source is illuminated to the appropriate intensity and color. In contrast, an LED light source that is rated for the voltage load control technique is characterized by a rated voltage (e.g., approximately 15 volts) to which the voltage across the LED light source should be regulated to ensure proper operation of the LED light source. Typically, each string of LEDs in an LED light source rated for the voltage load control technique includes a current balance regulation element to ensure that each of the parallel legs has the same impedance so that the same current is drawn in each parallel string.

It is known that the light output of an LED light source can be dimmed. Different methods of dimming LEDs include a pulse-width modulation (PWM) technique and a constant current reduction (CCR) technique. Pulse-width modulation dimming can be used for LED light sources that are controlled in either a current or voltage load control mode/technique. In pulse-width modulation dimming, a pulsed signal with a varying duty cycle is supplied to the LED light source. If an LED light source is being controlled using the current load control technique, the peak current supplied to the LED light source is kept constant during an on time of the duty cycle of the pulsed signal. However, as the duty cycle of the pulsed signal varies, the average current supplied to the LED light source also varies, thereby varying the intensity of the light output of the LED light source. If the LED light source is being controlled using the voltage load control technique, the voltage supplied to the LED light source is kept constant during the on time of the duty cycle of the pulsed signal in order to achieve the desired target voltage level, and the duty cycle of the load voltage is varied in order to adjust the intensity of the light output. Constant current reduction dimming is typically only used when an LED light source is being controlled using the current load control technique. In constant current reduction dimming, current is continuously provided to the LED light source, however, the DC magnitude of the current provided to the LED light source is varied to thus adjust the intensity of the light output. Examples of LED drivers are described in greater detail in commonly-assigned U.S. Pat. No. 8,492,987, issued Jul. 23, 2010, and U.S. Patent Application Publication No. 2013/0063047, published Mar. 14, 2013, both entitled LOAD CONTROL DEVICE FOR A LIGHT-EMITTING DIODE LIGHT SOURCE, the entire disclosures of which are hereby incorporated by reference.

Dimming an LED light source using traditional techniques may result in changes in light intensity that are perceptible to the human vision. This problem may be more apparent if the dimming occurs while the LED light source is near the low end of its intensity range (e.g., below 5% of a maximum intensity). Accordingly, systems, methods, and instrumentalities for fine-tuning the intensity of an LED light source may be desirable.

### SUMMARY

As described herein, a load control device for controlling the amount of power delivered to an electrical load may be able to adjust the average magnitude of a load current conducted through the electrical load. The load control device may comprise a load regulation circuit that is configured to control the magnitude of the load current to control the amount of power delivered to the electrical load. The load control device may comprise an inverter circuit characterized by an operating period. The load control device may further comprise a control circuit coupled to the load regulation circuit and configured to adjust an on time of the inverter circuit to control an average magnitude of the load current. The control circuit may be configured to operate in a normal mode and a burst mode. The burst mode may comprise an active state during an active state period of a burst mode period and an inactive state during an inactive state period of the burst mode period. During the normal mode, the control circuit may be configured to regulate the average magnitude of the load current by holding the active state and inactive state periods of the burst mode period constant and adjusting a target load current. During the burst mode, the control circuit may be configured to regulate the average magnitude of the load current by adjusting the lengths of the active state and inactive state periods of the burst mode period. During the burst mode, the control circuit may be configured to adjust the operating period of the inverter circuit by adjusting the on time of the inverter circuit until the on time is less than or equal to a minimum on time. During the normal mode, the control circuit may be configured to control the operating period of the inverter circuit between the adjusted low-end operating period and a high-end operating period, for example as a function of the load current.

The control circuit may be configured to adjust the operating period of the inverter circuit even if the control circuit is not configured to operate in the burst mode. The control circuit may adjust the operating period of the inverter circuit by adjusting the on time of the inverter circuit when a target load current is near or below a low-end transition value. The adjustment may be made until the on time of the inverter circuit is less than or equal to a minimum on time. When the target load current is greater than or equal to the low-end transition value, the control circuit may adjust the operating period of the inverter circuit between the adjusted low-end operating period and a high-end operating period, for example as a function of the load current.

### BRIEF DESCRIPTION OF THE DRAWINGS

FIG. 1 is a simplified block diagram of a light-emitting diode (LED) driver for controlling the intensity of an LED light source.

FIG. 2 is an example plot of a target load current of the LED driver of FIG. 1 as a function of a target intensity.

FIG. 3 is an example plot of a burst duty cycle of the LED driver of FIG. 1 as a function of the target intensity.

FIG. 4 is an example state diagram illustrating the operation of a load regulation circuit of the LED driver of FIG. 1 when operating in a burst mode.

FIG. 5 is a simplified schematic diagram of an isolated forward converter and a current sense circuit of an LED driver.

FIG. 6 is an example diagram illustrating a magnetic core set of an energy-storage inductor of a forward converter.

FIG. 7 shows example waveforms illustrating the operation of a forward converter and a current sense circuit when the intensity of an LED light source is near a high-end intensity.

FIG. 8 shows example waveforms illustrating the operation of a forward converter and a current sense circuit when the intensity of an LED light source is near a low-end intensity.

FIG. 9 shows example waveforms illustrating the operation of a forward converter of an LED driver when operating in a burst mode.

FIG. 10 is a diagram of an example waveform illustrating a load current when a load regulation circuit is operating in a burst mode.

FIG. 11 is an example plot showing how a relative average light level may change as a function of a number of inverter cycles included in an active state period when a load regulation circuit is operating in a burst mode.

FIG. 12 is an example plot showing how a burst duty cycle may change as a result of including one additional inverter cycle in an active state period when an inverter circuit is operating under two different low-end frequencies.

FIG. 13 is an example plot of an operating frequency of an LED driver as a function of a target intensity.

FIG. 14 shows example plots illustrating the operation of a control circuit and an inverter circuit of an LED driver during a burst mode.

FIG. 15 is a simplified flowchart of an example procedure for operating a forward converter of an LED driver in a normal mode and a burst mode.

FIG. 16 is a simplified flowchart of an example low-end period adjustment procedure.

### DETAILED DESCRIPTION

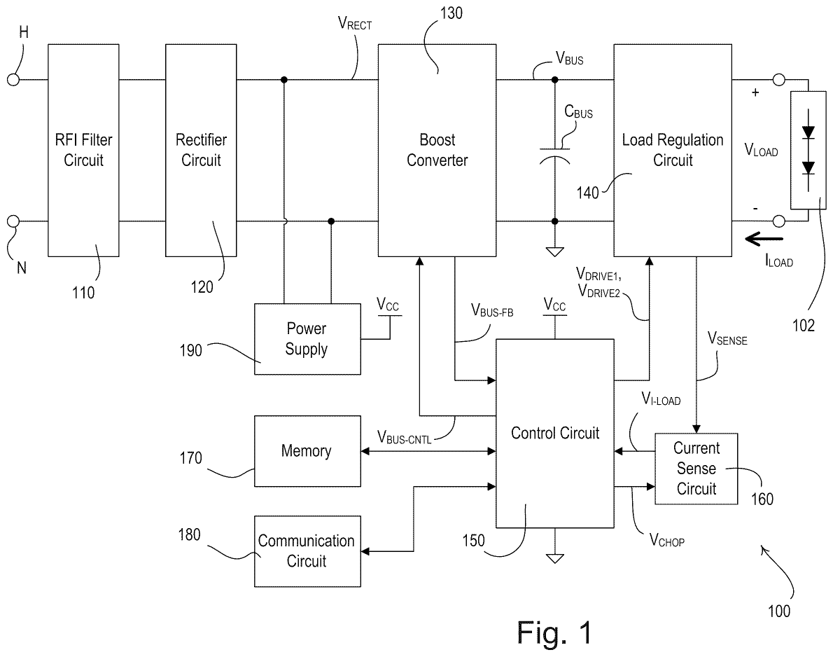

FIG. 1 is a simplified block diagram of a load control device, e.g., a light-emitting diode (LED) driver 100, for controlling the amount of power delivered to an electrical load, such as an LED light source 102 (e.g., an LED light engine), and thus the intensity of the electrical load. The LED light source 102 is shown as a plurality of LEDs connected in series but may comprise a single LED or a plurality of LEDs connected in parallel or a suitable combination thereof, depending on the particular lighting system. The LED light source 102 may comprise one or more organic light-emitting diodes (OLEDs). The LED driver 100 may comprise a hot terminal H and a neutral terminal N that are adapted to be coupled to an alternating-current (AC) power source (not shown).

The LED driver 100 may comprise a radio-frequency (RFI) filter circuit 110, a rectifier circuit 120, a boost converter 130, a load regulation circuit 140, a control circuit 150, a current sense circuit 160, a memory 170, a communication circuit 180, and/or a power supply 190. The RFI filter circuit 110 may minimize the noise provided on the AC mains. The rectifier circuit 120 may generate a rectified voltage V_{RECT}.

The boost converter 130 may receive the rectified voltage V_{RECT} and generate a boosted direct-current (DC) bus voltage V_{BUS} across a bus capacitor CBUS. The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 130 may operate as a power factor correction (PFC) circuit to adjust the power factor of the LED driver 100 towards a power factor of one.

The load regulation circuit 140 may receive the bus voltage V_{BUS} and control the amount of power delivered to the LED light source 102, for example, to control the intensity of the LED light source 102 between a low-end (i.e., minimum) intensity L_{LE} (e.g., approximately 1-5%) and a high-end (i.e., maximum) intensity L_{HE} (e.g., approximately 100%). An example of the load regulation circuit 140 may be an isolated, half-bridge forward converter. An example of the load control device (e.g., LED driver 100) comprising a forward converter is described in greater detail in commonly-assigned U.S. patent application Ser. No. 13/935,799, filed Jul. 5, 2013, entitled LOAD CONTROL DEVICE FOR A LIGHT-EMITTING DIODE LIGHT SOURCE, the entire disclosure of which is hereby incorporated by reference. The load regulation circuit 140 may comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. An example of the control circuit 150 may be a controller. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS}. The control circuit 150 may receive a bus voltage feedback control signal V_{BUS-FB} from the boost converter 130, which may indicate the magnitude of the bus voltage V_{BUS}.

The control circuit 150 may generate drive control signals V_{DRIVE1}, V_{DRIVE2}. The drive control signals V_{DRIVE1}, V_{DRIVE2} may be provided to the load regulation circuit 140 for adjusting the magnitude of a load voltage V_{LOAD} generated across the LED light source 102 and the magnitude of a load current I_{LOAD} conducted through the LED light source 102, for example, to control the intensity of the LED light source 102 to a target intensity L_{TRGT}. The control circuit 150 may adjust an operating frequency for and/or a duty cycle DC_{INV} (e.g., an on-time T_{ON}) of the drive control signals V_{DRIVE1}, V_{DRIVE2} to adjust the magnitude of the load voltage V_{LOAD} and/or the load current I_{LOAD}.

The current sense circuit 160 may receive a sense voltage V_{SENSE} generated by the load regulation circuit 140. The sense voltage V_{SENSE} may indicate the magnitude of the load current I_{LOAD}. The current sense circuit 160 may receive a signal-chopper control signal V_{CHOP} from the control circuit 150. The current sense circuit 160 may generate a load current feedback signal V_{I-LOAD}, which may be a DC voltage indicating the average magnitude I_{AVE} of the load current I_{LOAD}. The control circuit 150 may receive the load current feedback signal V_{I-LOAD} from the current sense circuit 160 and control the drive control signals V_{DRIVE1}, V_{DRIVE2} accordingly. For example, the control circuit 150 may control the drive control signals V_{DRIVE1}, V_{DRIVE2} to adjust a magnitude of the load current I_{LOAD} to a target load current I_{TRGT} to thus control the intensity of the LED light source 102 to the target intensity L_{TRGT} (e.g., using a control loop).

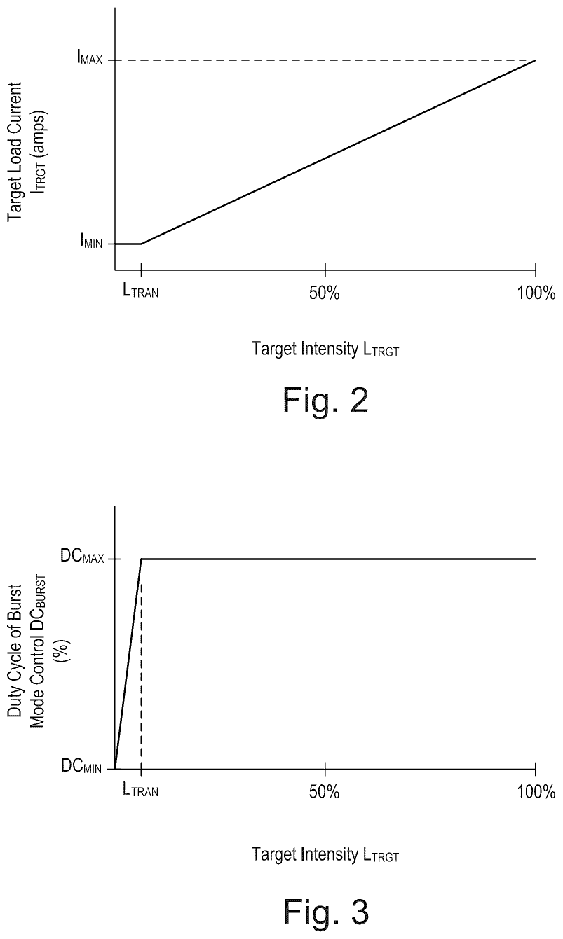

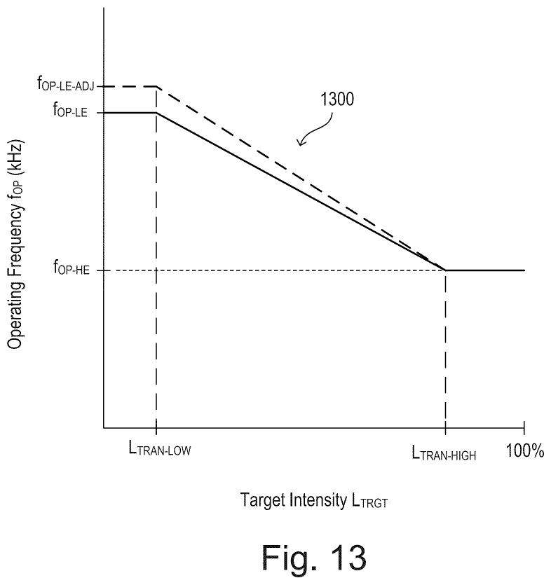

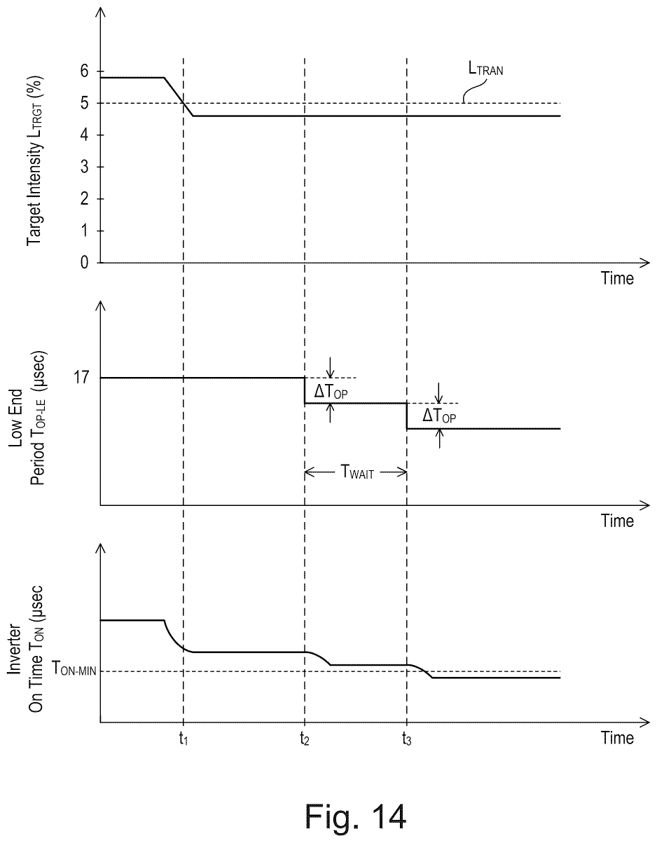

The load current I_{LOAD} may be the current that is conducted through the LED light source 102. The target load current I_{TRGT} may be the current that the control circuit 150 would ideally like to conduct through the LED light source 102 (e.g., based at least on the load current feedback signal V_{I-LOAD}). The control circuit 150 may be limited to specific levels of granularity in which it can control the current conducted through the LED light source 102 (e.g., due to inverter cycle lengths, etc.), so the control circuit 150 may not always be able to achieve the target load current I_{TRGT}. For example, FIGS. 2 and 13 illustrate the current conducted through an LED light source as a linear graph (at least in parts), and as such, illustrate the target load current I_{TRGT} since the load current I_{LOAD} itself may not actually follow a true linear path. Further, non-ideal reactions of the LED light source 102 (e.g., an overshoot in the load current I_{LOAD}, for example, as shown in FIG. 14A) may cause the load current I_{LOAD} to deviate from the target load current I_{TRGT}. In the ideal situation, the load current I_{LOAD} is approximately equal to the target load current I_{TRGT}.

The control circuit 150 may be coupled to the memory 170. The memory 170 may store operational characteristics of the LED driver 100 (e.g., the target intensity L_{TRGT}, the low-end intensity L_{LE}, the high-end intensity L_{HE}, etc.). The communication circuit 180 may be coupled to, for example, a wired communication link or a wireless communication link, such as a radio frequency (RF) communication link or an infrared (IR) communication link. The control circuit 150 may be configured to update the target intensity L_{TRGT} of the LED light source 102 and/or the operational characteristics stored in the memory 170 in response to digital messages received via the communication circuit 180. The LED driver 100 may be operable to receive a phase-control signal from a dimmer switch for determining the target intensity L_{TRGT} for the LED light source 102. The power supply 190 may receive the rectified voltage V_{RECT} and generate a direct-current (DC) supply voltage V_{CC} for powering the circuitry of the LED driver 100.

FIG. 2 is an example plot of the target load current I_{TRGT} as a function of the target intensity L_{TRGT}. The magnitude of the load current I_{LOAD} may only be regulated to values between a maximum rated current I_{MAX} and a minimum rated current I_{MIN}, for example, due to hardware limitations of the load regulation circuit 140 and the control circuit 150. Thus, the target load current I_{TRGT} may only be adjusted between the maximum rated current I_{MAX} and the minimum rated current I_{MIN}. When the target intensity L_{TRGT} is between the high-end intensity L_{HE} (e.g., approximately 100%) and a transition intensity L_{TRAN} (e.g., approximately 5%), the control circuit 150 may operate the load regulation circuit 140 in a normal mode in which an average magnitude I_{AVE} of the load current I_{LOAD} is controlled to be equal to the target load current I_{TRGT}. In the normal mode, the control circuit 150 may adjust the average magnitude I_{AVE} of the load current I_{LOAD} to the target load current I_{TRGT} in response to the load current feedback signal V_{I-LOAD}, e.g., using closed loop control. The control circuit 150 may adjust the target load current I_{TRGT} between the maximum rated current I_{MAX} and the minimum rated current I_{MIN} in the normal mode, for example, as shown in FIG. 2.

FIG. 3 is an example plot of a burst duty cycle DC_{BURST} (e.g., an ideal burst duty cycle DC_{BURST-IDEAL}) as a function of the target intensity L_{TRGT}. When the target intensity L_{TRGT} is between the high-end intensity L_{HE} (e.g., approximately 100%) and a transition intensity L_{TRAN} (e.g., approximately 5%), the control circuit 150 may be configured to operate the load regulation circuit 140 to set the burst duty cycle DC_{BURST} equal to a maximum duty cycle DC_{MAX} (e.g., approximately 100%). To adjust the target intensity L_{TRGT} below the transition intensity L_{TRAN}, the control circuit 150 may be configured to operate the load regulation circuit 140 in a burst mode to reduce the average magnitude I_{AVE} of the load current I_{LOAD} to be less the minimum rated current I_{MIN}. For example, to adjust the target intensity L_{TRGT} below the transition intensity L_{TRAN}, the control circuit 150 may be configured to operate the load regulation circuit 140 to reduce the burst duty cycle DC_{BURST} below the maximum duty cycle DC_{MAX}. For example, the load regulation circuit 140 may adjust the burst duty cycle DC_{BURST} between the maximum duty cycle DC_{MAX} (e.g., approximately 100%) and a minimum duty cycle DC_{MIN} (e.g., approximately 20%). In the burst mode, a peak magnitude I_{PK} of the load current I_{LOAD} may be equal to the target current I_{TRGT} (e.g., the minimum rated current I_{MIN}). For example, the peak magnitude I_{PK} of the load current I_{LOAD} may be equal to the minimum rated current I_{MIN} during an active state of the burst mode.

With reference to FIG. 3, the burst duty cycle DC_{BURST} may refer to an ideal burst duty cycle DC_{BURST-IDEAL}, which may include an integer portion DC_{BURST-INTEGER} and/or a fractional portion DC_{BURST-FRACTIONAL}. The integer portion DC_{BURST-INTEGER} may be characterized by the percentage of the ideal burst duty cycle DC_{BURST-IDEAL} that includes complete inverter cycles (i.e., an integer value of inverter cycles). The fractional portion DC_{BURST-FRACTIONAL} may be characterized by the percentage of the ideal burst duty cycle DC_{BURST-IDEAL} that includes a fraction of an inverter cycle. As described herein, the control circuit 150 (e.g., via the load regulation circuit 140) may be configured to adjust the number of inverter cycles only by an integer number (i.e., by DC_{BURST-INTEGER}) and not a fractional amount (i.e., DC_{BURST-FRACTIONAL}). Therefore, the example plot of FIG. 3 may illustrate an ideal curve showing the adjustment of the ideal burst duty cycle DC_{BURST-IDEAL} from a maximum duty cycle DC_{MAX} to a minimum duty cycle DC_{MIN} when the target intensity L_{TRGT} is below the transition intensity L_{TRAN}. Nonetheless, unless defined differently, burst duty cycle DC_{BURST} may refer to the integer portion DC_{BURST-INTEGER} of the ideal burst duty cycle DC_{BURST-IDEAL}, for example, if the control circuit 150 is not configured to operate the burst duty cycle DC_{BURST} at fractional amounts.

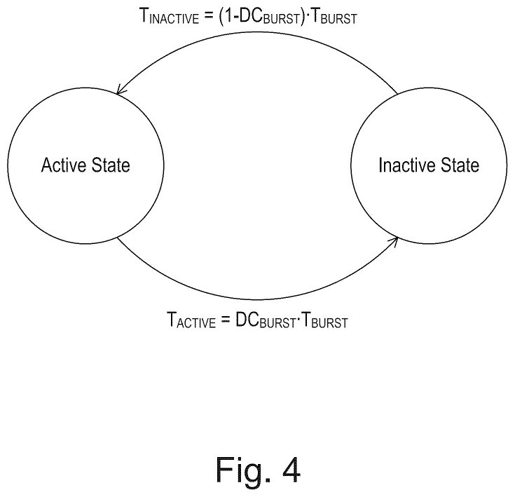

FIG. 4 is an example state diagram illustrating the operation of the load regulation circuit 140 in the burst mode. During the burst mode, the control circuit 150 may periodically control the load regulation circuit 140 into an active state and an inactive state, e.g., in dependence upon a burst duty cycle DC_{BURST} and a burst mode period T_{BURST} (e.g., approximately 4.4 milliseconds). For example, the active state period (T_{ACTIVE}) may be equal to the burst duty cycle (DC_{BURST}) times the burst mode period (T_{BURST}) and the inactive state period (T_{INACTIVE}) may be equal to one minus the burst duty cycle (DC_{BURST}) times the burst mode period (T_{BURST}). That is, T_{ACTIVE}=DC_{BURST}·T_{BURST} and T_{INACTIVE}=(1−DC_{BURST}). T_{BURST}.

In the active state of the burst mode, the control circuit 150 may generate (e.g., actively generate) the drive control signals V_{DRIVE1}, V_{DRIVE2} to adjust the magnitude (e.g., the peak magnitude I_{PK}) of the load current I_{LOAD}, e.g., using closed loop control. For example, in the active state of the burst mode, the control circuit 150 may generate the drive signals V_{DRIVE1}, V_{DRIVE2} to adjust the magnitude of the load current I_{LOAD} to be equal to a target load current I_{TRGT} (e.g., the minimum rated current I_{MIN}) in response to the load current feedback signal V_{I-LOAD}.

In the inactive state of the burst mode, the control circuit 150 may freeze the control loop and may not generate the drive control signals V_{DRIVE1}, V_{DRIVE2}, for example, such that the magnitude of the load current I_{LOAD} drops to approximately zero amps. While the control loop is frozen (e.g., in the inactive state), the control circuit 150 may not adjust the values of the operating frequency for and/or the duty cycle DC_{INV} in response to the load current feedback signal V_{I-LOAD} (e.g., even though the control circuit 150 is not presently generating the drive signals V_{DRIVE1}, V_{DRIVE2}). For example, the control circuit 150 may store the present duty cycle DC_{INV} (e.g., the present on-time T_{ON}) of the drive control signals V_{DRIVE1}, V_{DRIVE2} in the memory 170 prior to (e.g., immediately prior to) freezing the control loop. Accordingly, when the control loop is unfrozen (e.g., when the control circuit 150 enters the active state), the control circuit 150 may continue to generate the drive control signals V_{DRIVE1}, V_{DRIVE2} using the operating frequency f_{OP} and/or the duty cycle DC_{INV} from the previous active state.

The control circuit 150 may be configured to adjust the burst duty cycle DC_{BURST} using an open loop control. For example, the control circuit 150 may be configured to adjust the burst duty cycle DC_{BURST} as a function of the target intensity L_{TRGT}, for example, when the target intensity L_{TRGT} is below the transition intensity L_{TRAN}. The control circuit 150 may be configured to linearly decrease the burst duty cycle DC_{BURST} as the target intensity L_{TRGT} is decreased below the transition intensity L_{TRAN} (e.g., as shown in FIG. 3), while the target load current I_{TRGT} is held constant at the minimum rated current I_{MIN} (e.g., as shown in FIG. 2). Since the control circuit 150 changes between the active state and the inactive state in dependence upon the burst duty cycle DC_{BURST} and the burst mode period T_{BURST} (e.g., as shown in the state diagram of FIG. 4), the average magnitude I_{AVE} of the load current I_{LOAD} may be a function of the burst duty cycle DC_{BURST} (e.g., I_{AVE}=DC_{BURST}·I_{MIN}). During the burst mode, the peak magnitude I_{PK} of the load current I_{LOAD} may be equal to the minimum rated current I_{MIN}, but the average magnitude I_{AVE} of the load current I_{LOAD} may be less than the minimum rated current I_{MIN}.

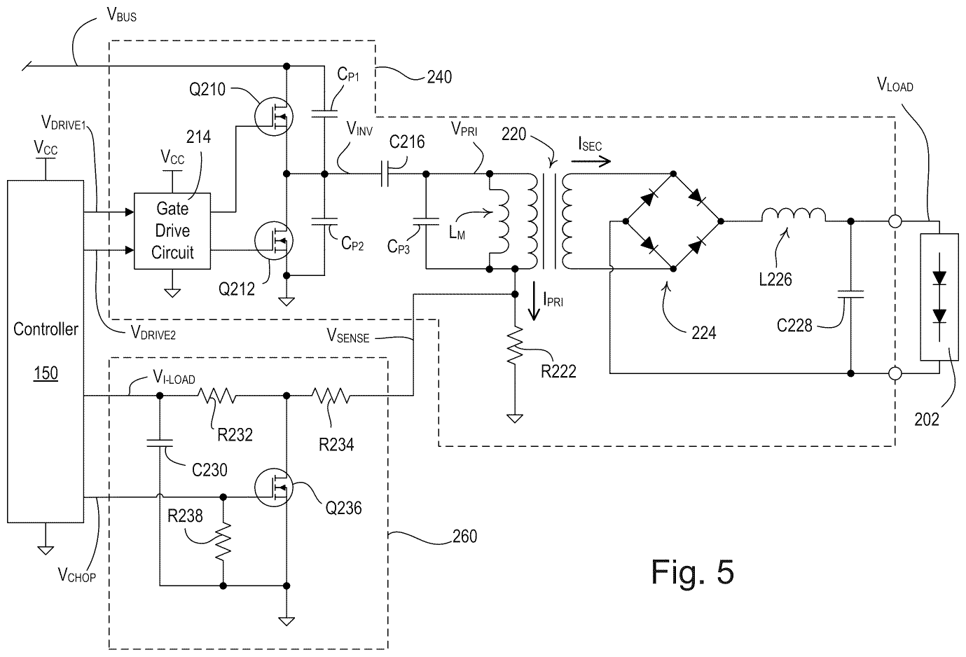

FIG. 5 is a simplified schematic diagram of a forward converter 240 and a current sense circuit 260 of an LED driver (e.g., the LED driver 100 shown in FIG. 1). The forward converter 240 may be an example of the load regulation circuit 140 of the LED driver 100 shown in FIG. 1. The current sense circuit 260 may be an example of the current sense circuit 160 of the LED driver 100 shown in FIG. 1.

The forward converter 240 may comprise a half-bridge inverter circuit having two field effect transistors (FETs) Q210, Q212 for generating a high-frequency inverter voltage V_{INV} from the bus voltage V_{BUS}. The FETs Q210, Q212 may be rendered conductive and non-conductive in response to the drive control signals V_{DRIVE1}, V_{DRIVE2}. The drive control signals V_{DRIVE1}, V_{DRIVE2} may be received from the control circuit 150. The drive control signals V_{DRIVE1}, V_{DRIVE2} may be coupled to the gates of the respective FETs Q210, Q212 via a gate drive circuit 214 (e.g., which may comprise part number L6382DTR, manufactured by ST Microelectronics). The control circuit 150 may generate the inverter voltage V_{INV} at a constant operating frequency for (e.g., approximately 60-65 kHz) and thus a constant operating period T_{OP}. However, the operating frequency for and/or operating period T_{OP} may be adjusted under certain operating conditions. For example, the operating frequency for may be adjusted (e.g., increased or decreased) as the target intensity L_{TRGT} of the LED light source 202 is adjusted towards the high-end intensity L_{HE} (e.g., as shown in FIG. 13). For example, the operating frequency f_{OP} may be adjusted (e.g., increased or decreased) as the target intensity L_{TRGT} of the LED light source 202 is adjusted towards the transition intensity L_{TRAN}. The control circuit 150 may be configured to adjust a duty cycle DC_{INV} of the inverter voltage V_{INV} to control the intensity of the LED light source 202 towards the target intensity L_{TRGT}.

In a normal mode of operation, when the target intensity L_{TRGT} of the LED light source 202 is between the high-end intensity L_{HE} and the transition intensity L_{TRAN}, the control circuit 150 may adjust the duty cycle DC_{INV} of the inverter voltage V_{INV} to adjust the magnitude (e.g., the average magnitude I_{AVE}) of the load current I_{LOAD} towards the target load current I_{TRGT}. As previously mentioned, the magnitude of the load current I_{LOAD} may vary between the maximum rated current I_{MAX} and the minimum rated current I_{MIN} (e.g., as shown in FIG. 2). For example, the minimum rated current I_{MIN} may be chosen based on a minimum on-time T_{ON-MIN} of the half-bridge inverter circuit of the forward converter 240. The value of the minimum on-time T_{ON-MIN} may be set such that the on time of the half-bridge inverter circuit may be maintained within the hardware limitations of the forward converter. At the minimum rated current I_{MIN} (e.g., at the transition intensity L_{TRAN}), the inverter voltage V_{INV} may be characterized by a low-end operating frequency f_{OP-LE} and a low-end operating period T_{OP-LE}.

When the target intensity L_{TRGT} of the LED light source 202 is below the transition intensity L_{TRAN}, the control circuit 150 may be configured to operate the forward converter 240 in a burst mode of operation. The control circuit 150 may use power (e.g., a transition power) and/or current (e.g., a transition current) as a threshold to determine when to operate in the burst mode (e.g., instead of intensity). In the burst mode of operation, the control circuit 150 may be configured to switch the forward converter 240 between an active mode (e.g., in which the control circuit 150 actively generates the drive control signals V_{DRIVE1}, V_{DRIVER2} to regulate the peak magnitude I_{PK} of the load current I_{LOAD} to be equal to the minimum rated current I_{MIN}) and an inactive mode (e.g., in which the control circuit 150 freezes the control loop and does not generate the drive control signals V_{DRIVE1}, V_{DRIVE2}), for example, as shown in the state diagram of FIG. 4. In the burst mode, the control circuit 150 may change the forward converter 240 between the active state and the inactive state in dependence upon a burst duty cycle DC_{BURST} and a burst mode period T_{BURST} (e.g., as shown in FIG. 4) and adjust the burst duty cycle DC_{BURST} as a function of the target intensity L_{TRGT}, which is below the transition intensity L_{TRAN} (e.g., as shown in FIG. 3). In the normal mode and in the active state of the burst mode, the forward converter 240 may be characterized by a turn-on time T_{TURN-ON} and a turn-off time T_{TURN-OFF}. The turn-on time T_{TURN-ON} may be a time period from when the drive control signals V_{DRIVE1}, V_{DRIVE2} are driven until the respective FET Q210, Q212 is rendered conductive. The turn-off time T_{TURN-OFF} may be a time period from when the drive control signals V_{DRIVE1}, V_{DRIVE2} are driven until the respective FET Q210, Q212 is rendered non-conductive.

The inverter voltage V_{INV} is coupled to the primary winding of a transformer 220 through a DC-blocking capacitor C216 (e.g., which may have a capacitance of approximately 0.047 μF), such that a primary voltage V_{PRI} is generated across the primary winding. The transformer 220 may be characterized by a turns ratio n_{TURNS} (i.e., N₁/N₂), which may be approximately 115:29. A sense voltage V_{SENSE} may be generated across a sense resistor R222, which may be coupled in series with the primary winding of the transformer 220. The FETs Q210, Q212 and the primary winding of the transformer 220 may be characterized by parasitic capacitances C_{P1}, C_{P2}, C_{P3}, respectively. The secondary winding of the transformer 220 may generate a secondary voltage. The secondary voltage may be coupled to the AC terminals of a full-wave diode rectifier bridge 224 for rectifying the secondary voltage generated across the secondary winding. The positive DC terminal of the rectifier bridge 224 may be coupled to the LED light source 202 through an output energy-storage inductor L226 (e.g., which may have an inductance of approximately 10 mH), such that the load voltage V_{LOAD} may be generated across an output capacitor C228 (e.g., which may have a capacitance of approximately 3 μF).

The current sense circuit 260 may comprise an averaging circuit for producing the load current feedback signal V_{I-LOAD}. The averaging circuit may comprise a low-pass filter comprising a capacitor C230 (e.g., which may have a capacitance of approximately 0.066 μF) and a resistor R232 (e.g., which may have a resistance of approximately 3.32 kΩ). The low-pass filter may receive the sense voltage V_{SENSE} via a resistor R234 (e.g., which may have a resistance of approximately 1 kΩ). The current sense circuit 260 may comprise a transistor Q236 (e.g., a FET as shown in FIG. 5) coupled between the junction of the resistors R232, R234 and circuit common. The gate of the transistor Q236 may be coupled to circuit common through a resistor R238 (e.g., which may have a resistance of approximately 22 kΩ). The gate of the transistor Q236 may receive the signal-chopper control signal V_{CHOP} from the control circuit 150. An example of the current sense circuit 260 may be described in greater detail in commonly-assigned U.S. patent application Ser. No. 13/834,153, filed Mar. 15, 2013, entitled FORWARD CONVERTER HAVING A PRIMARY-SIDE CURRENT SENSE CIRCUIT, the entire disclosure of which is hereby incorporated by reference.

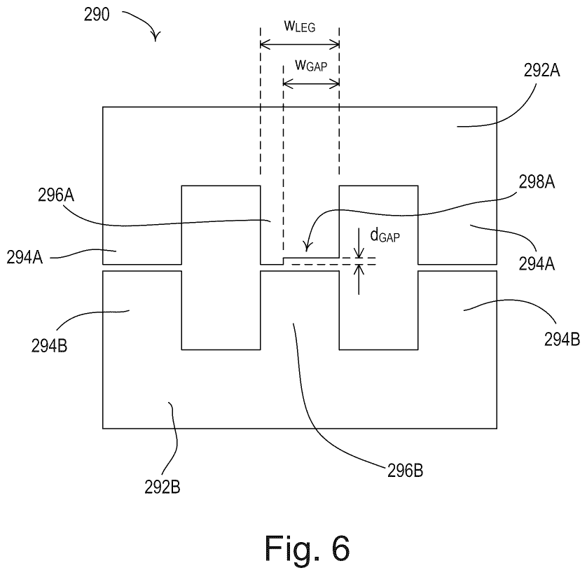

FIG. 6 is an example diagram illustrating a magnetic core set 290 of an energy-storage inductor (e.g., the output energy-storage inductor L226 of the forward converter 240 shown in FIG. 5). The magnetic core set 290 may comprise two E-cores 292A, 292B, and may comprise part number PC40EE16-Z, manufactured by TDK Corporation. The E-cores 292A, 292B may comprise respective outer legs 294A, 294B and inner legs 296A, 296B. Each inner leg 296A, 296B may be characterized by a width W_{LEG} (e.g., approximately 4 mm). The inner leg 296A of the first E-core 292A may comprise a partial gap 298A (i.e., the magnetic core set 290 is partially gapped), such that the inner legs 296A, 296B are spaced apart by a gap distance d_{GAP} (e.g., approximately 0.5 mm). The partial gap 298A may extend for a gap width w_{GAP} (e.g., approximately 2.8 mm) such that the partial gap 298A extends for approximately 70% of the leg width W_{LEG} of the inner leg 296A. In one or more embodiments, both of the inner legs 296A, 296B may comprise partial gaps. The partially-gapped magnetic core set 290 (e.g., as shown in FIG. 6) may allow the output energy-storage inductor L226 of the forward converter 240 (e.g., shown in FIG. 5) to maintain continuous current at low load conditions (e.g., near the low-end intensity L_{LE}).

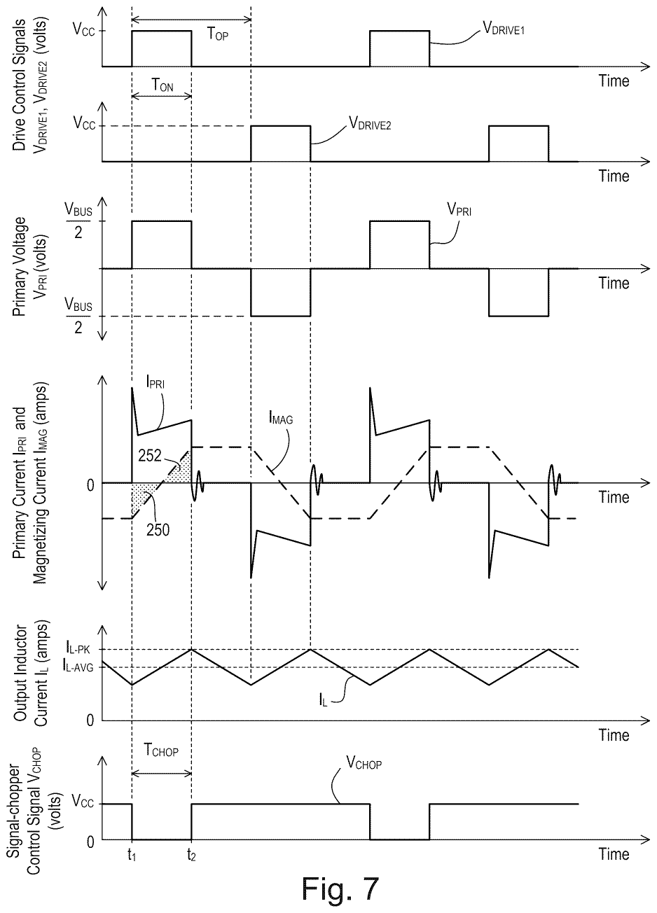

FIG. 7 shows example waveforms illustrating the operation of a forward converter and a current sense circuit, for example, the forward converter 240 and the current sense circuit 260 shown in FIG. 5. For example, the forward converter 240 may generate the waveforms shown in FIG. 7 when operating in the normal mode and in the active state of the burst mode as described herein. As shown in FIG. 7, a control circuit (e.g., the control circuit 150) may drive the respective drive control signals V_{DRIVE1}, V_{DRIVE2} high to approximately the supply voltage V_{CC} to render the respective FETs Q210, Q212 conductive for an on-time T_{ON} at different times (i.e., the FETs Q210, Q212 are conductive at different times). When the high-side FET Q210 is conductive, the primary winding of the transformer 220 may conduct a primary current I_{PRI} to circuit common through the capacitor C216 and sense resistor R222. After (e.g., immediately after) the high-side FET Q210 is rendered conductive (at time t₁ in FIG. 7), the primary current I_{PRI} may conduct a short high-magnitude pulse of current due to the parasitic capacitance C_{P3} of the transformer 220 as shown in FIG. 7. While the high-side FET Q210 is conductive, the capacitor C216 may charge, such that a voltage having a magnitude of approximately half of the magnitude of the bus voltage V_{BUS} is developed across the capacitor. Accordingly, the magnitude of the primary voltage V_{PRI} across the primary winding of the transformer 220 may be equal to approximately half of the magnitude of the bus voltage V_{BUS} (i.e., V_{BUS}/2). When the low-side FET Q212 is conductive, the primary winding of the transformer 220 may conduct the primary current I_{PRI} in an opposite direction and the capacitor C216 may be coupled across the primary winding, such that the primary voltage V_{PRI} may have a negative polarity with a magnitude equal to approximately half of the magnitude of the bus voltage V_{BUS}.

When either of the high-side and low-side FETs Q210, Q212 is conductive, the magnitude of an output inductor current I_{L}, conducted by the output inductor L226 and the magnitude of the load voltage V_{LOAD} across the LED light source 202 may increase with respect to time. The magnitude of the primary current I_{PRI} may increase with respect to time while the FETs Q210, Q212 are conductive (e.g., after an initial current spike). When the FETs Q210, Q212 are non-conductive, the output inductor current I_{L}, and the load voltage V_{LOAD} may decrease in magnitude with respective to time. The output inductor current I_{L}, may be characterized by a peak magnitude I_{L-PK} and an average magnitude I_{L-AVG}, for example, as shown in FIG. 7. The control circuit 150 may increase and/or decrease the on times T_{ON} of the drive control signals V_{DRIVE1}, V_{DRIVE2} (e.g., and the duty cycle DC_{INV} of the inverter voltage V_{INV}) to respectively increase and decrease the average magnitude I_{L-AVG} of the output inductor current I_{L}, and thus respectively increase and decrease the intensity of the LED light source 202.

When the FETs Q210, Q212 are rendered non-conductive, the magnitude of the primary current I_{PRI} may drop toward zero amps (e.g., as shown at time t₂ in FIG. 7 when the high-side FET Q210 is rendered non-conductive). However, a magnetizing current I_{MAG} may continue to flow through the primary winding of the transformer 220 due to the magnetizing inductance L_{MAG} of the transformer. When the target intensity L_{TRGT} of the LED light source 202 is near the low-end intensity L_{LE}, the magnitude of the primary current I_{PRI} may oscillate after either of the FETs Q210, Q212 is rendered non-conductive, for example, due to the parasitic capacitances C_{P1}, C_{P2} of the FETs, the parasitic capacitance C_{P3} of the primary winding of the transformer 220, and/or any other parasitic capacitances of the circuit, such as, parasitic capacitances of the printed circuit board on which the forward converter 240 is mounted.

The real component of the primary current I_{PRI} may indicate the magnitude of the secondary current I_{SEC} and thus the intensity of the LED light source 202. However, the magnetizing current I_{MAG} (i.e., the reactive component of the primary current I_{PRI}) may also flow through the sense resistor R222. The magnetizing current I_{MAG} may change from a negative polarity to a positive polarity when the high-side FET Q210 is conductive, change from a positive polarity to a negative polarity when the low-side FET Q212 is conductive, and remain constant when the magnitude of the primary voltage V_{PRI} is zero volts, for example, as shown in FIG. 7. The magnetizing current I_{MAG} may have a maximum magnitude defined by the following equation:

$${I}_{M A G - M A X} = \frac{{V}_{B U S} \cdot {T}_{H C}}{4 \cdot {L}_{M A G}}$$

where T_{HC} may be the half-cycle period of the inverter voltage V_{INV}, i.e., T_{HC}=T_{OP}/2. As shown in FIG. 7, the areas 250, 252 are approximately equal, such that the average value of the magnitude of the magnetizing current I_{MAG} is zero during the period of time when the magnitude of the primary voltage V_{PRI} is greater than approximately zero volts (e.g., during the on-time T_{ON} as shown in FIG. 7).

The current sense circuit 260 may determine an average the primary current I_{PRI} during the positive cycles of the inverter voltage V_{INV}, i.e., when the high-side FET Q210 is conductive (e.g., during the on-time T_{ON}). The load current feedback signal V_{I-LOAD}, which may be generated by the current sense circuit 260, may have a DC magnitude that is the average value of the primary current I_{PRI} when the high-side FET Q210 is conductive. Because the average value of the magnitude of the magnetizing current I_{MAG} is approximately zero during the period of time that the high-side FET Q210 is conductive (e.g., during the on-time T_{ON}), the load current feedback signal V_{I-LOAD} generated by the current sense circuit indicates the real component (e.g., only the real component) of the primary current I_{PRI} during the on-time T_{ON}.

When the high-side FET Q210 is rendered conductive, the control circuit 150 may drive the signal-chopper control signal V_{CHOP} low towards circuit common to render the transistor Q236 of the current sense circuit 260 non-conductive for a signal-chopper time T_{CHOP}. The signal-chopper time T_{CHOP} may be approximately equal to the on-time T_{ON} of the high-side FET Q210, for example, as shown in FIG. 7. The capacitor C230 may charge from the sense voltage V_{SENSE} through the resistors R232, R234 while the signal-chopper control signal V_{CHOP} is low, such that the magnitude of the load current feedback signal V_{I-LOAD} is the average value of the primary current I_{PRI} and thus indicates the real component of the primary current during the time when the high-side FET Q210 is conductive. When the high-side FET Q210 is not conductive, the control circuit 150 drives the signal-chopper control signal V_{CHOP} high to render the transistor Q236 conductive. Accordingly, the control circuit 150 is able to accurately determine the average magnitude of the load current I_{LOAD} from the magnitude of the load current feedback signal V_{I-LOAD} since the effects of the magnetizing current I_{MAG} and the oscillations of the primary current I_{PRI} on the magnitude of the load current feedback signal V_{I-LOAD} are reduced or eliminated completely.

As the target intensity L_{TRGT} of the LED light source 202 is decreased towards the low-end intensity L_{LE} and the on times T_{ON} of the drive control signals V_{DRIVE1}, V_{DRIVE2} get smaller, the parasitics of the load regulation circuit 240 (i.e., the parasitic capacitances C_{P1}, C_{P2} of the FETs Q210, Q212, the parasitic capacitance C_{P3} of the primary winding of the transformer 220, and/or other parasitic capacitances of the circuit) may cause the magnitude of the primary voltage V_{PRI} to slowly decrease towards zero volts after the FETs Q210, Q212 are rendered non-conductive.

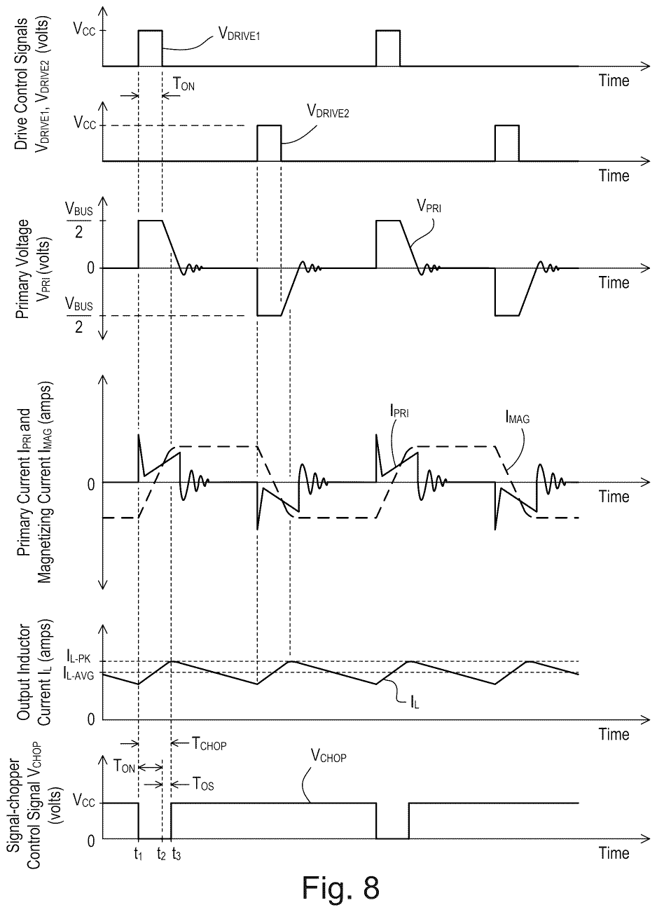

FIG. 8 shows example waveforms illustrating the operation of a forward converter and a current sense circuit (e.g., the forward converter 240 and the current sense circuit 260) when the target intensity L_{TRGT} is near the low-end intensity L_{LE}, and when the forward converter 240 is operating in the normal mode and the active state of the burst mode. The gradual drop-off in the magnitude of the primary voltage V_{PRI} may allow the primary winding of the transformer 220 to continue to conduct the primary current I_{PRI}, such that the transformer 220 may continue to deliver power to the secondary winding after the FETs Q210, Q212 are rendered non-conductive, for example, as shown in FIG. 8. The magnetizing current I_{MAG} may continue to increase in magnitude after the on-time T_{ON} of the drive control signal V_{DRIVE1} (e.g., and/or the drive control signal V_{DRIVE2}). Accordingly, the control circuit 150 may increase the signal-chopper time T_{CHOP} to be greater than the on-time T_{ON}. For example, the control circuit 150 may increase the signal-chopper time T_{CHOP} (e.g., during which the signal-chopper control signal V_{CHOP} is low) by an offset-time T_{OS} when the target intensity L_{TRGT} of the LED light source 202 is near the low-end intensity L_{LE}.

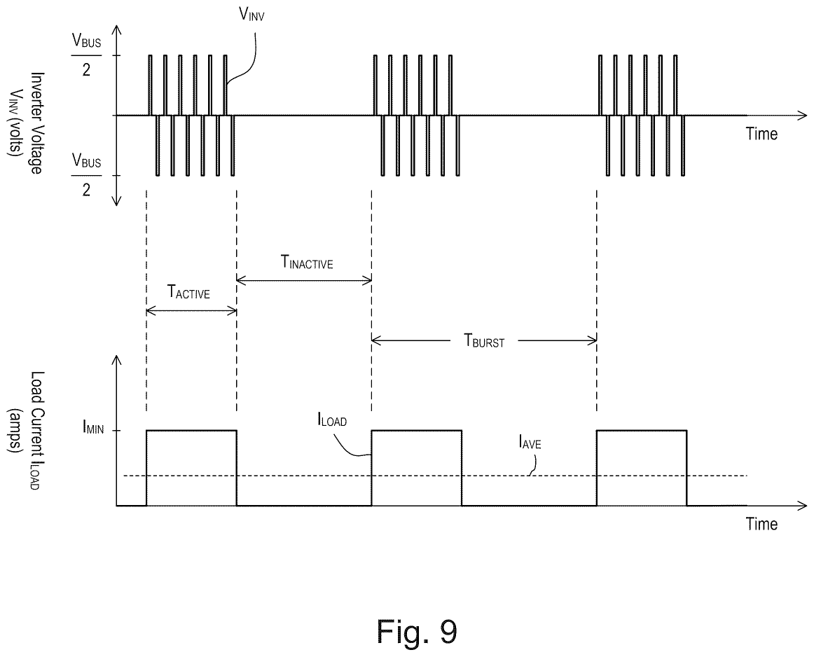

FIG. 9 shows example waveforms illustrating the operation of a forward converter when operating in a burst mode (e.g., the forward converter 240 shown in FIG. 5). The inverter circuit of the forward converter 240 may generate the inverter voltage V_{INV} during the active state (e.g., for length of an active state period T_{ACTIVE} as shown in FIG. 9), for example, such that the magnitude of the load current I_{LOAD} may be regulated to the minimum rated current I_{MIN}. The inverter voltage V_{INV} may not be generated during the inactive state (e.g., for an inactive state period T_{INACTIVE}). The active state may begin on a periodic basis at a burst mode period T_{BURST} (e.g., approximately 4.4 milliseconds). The active state period T_{ACTIVE} and inactive state period T_{INACTIVE} may be characterized by durations that are dependent upon a burst duty cycle DC_{BURST}. For example, T_{ACTIVE}=DC_{BURST}·T_{BURST} and T_{INACTIVE}=(1−DC_{BURST}). T_{BURST}. The average magnitude I_{AVE} of the load current I_{LOAD} may be dependent on the burst duty cycle DC_{BURST}. For example, the average magnitude I_{AVE} of the load current I_{LOAD} may be equal to the burst duty cycle DC_{BURST} times the load current I_{LOAD} (e.g., I_{AVE}=DC_{BURST}·I_{LOAD}), which in one example may be the minimum load current I_{MIN} (e.g., I_{AVE}=DC_{BURST}·I_{MIN}).

The burst duty cycle DC_{BURST} may be controlled to adjust the average magnitude I_{AVE} of the load current I_{LOAD}. For example, the burst mode period T_{BURST} may be held constant and the length of the active state period T_{ACTIVE} may be varied to adjust the duty cycle DC_{BURST}, which in turn may vary the average magnitude I_{AVE} of the load current I_{LOAD}. For example, the active state period T_{ACTIVE} may be held constant, and the length of burst mode period T_{BURST} may be varied to adjust the burst duty cycle DC_{BURST}, which in turn may vary the average magnitude I_{AVE} of the load current I_{LOAD}. Accordingly, as the burst duty cycle DC_{BURST} is increased, the average magnitude I_{AVE} of the load current I_{LOAD} may increase, and as the burst duty cycle DC_{BURST} is decreased, the average magnitude I_{AVE} of the load current I_{LOAD} may decrease. As described herein, the control circuit 150 may adjust the burst duty cycle DC_{BURST} in response to the target intensity L_{TRGT} using open loop control. The control circuit 150 may be configured to adjust the burst duty cycle DC_{BURST} using closed loop control (e.g., in response to the load current feedback signal V_{I-LOAD}).

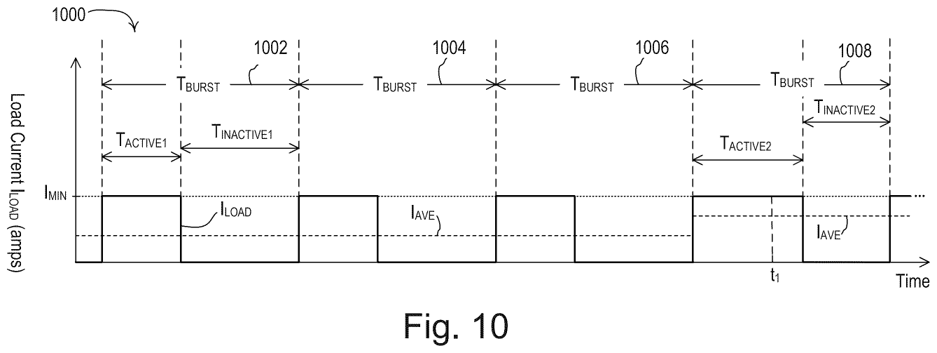

FIG. 10 is a diagram of an example waveform 1000 illustrating the load current I_{LOAD} when a load regulation circuit (e.g., the load regulation circuit 240) is operating in a burst mode, for example, as the target intensity L_{TRGT} of a light source (e.g., the LED light source 202) is increased (e.g., from the low-end intensity L_{LE}). A control circuit (e.g., the control circuit 150 of the LED driver 100 shown in FIG. 1 and/or the control circuit 150 controlling the forward converter 240 and the current sense circuit 260 shown in FIG. 5) may adjust the length of the active state period T_{ACTIVE} of the burst mode period T_{BURST} by adjusting the burst duty cycle DC_{BURST}. Adjusting the length of the active state period T_{ACTIVE} may adjust the average magnitude I_{AVE} of the load current I_{LOAD}, and in turn the intensity of the light source.

The active state period T_{ACTIVE} of the load current I_{LOAD} may have a length that is dependent upon the length of an inverter cycle of the inverter circuit of the load regulation circuit (e.g., the operating period T_{OP}). For example, referring to FIG. 9, the active state period T_{ACTIVE} may comprise six inverter cycles, and as such, may have a length that is equal to the duration of the six inverter cycles. The control circuit may adjust (e.g., increase or decrease) the active state period T_{ACTIVE} by adjusting the number of inverter cycles in the active state period T_{ACTIVE}. As such, the control circuit may adjust the active state period T_{ACTIVE} by predetermined time intervals that each correspond to the length of an inverter cycle of the inverter circuit of the load regulation circuit. For example, the adjustment to the active state period T_{ACTIVE} may be made in one or more steps (e.g., with a substantially equal amount of adjustment in each step). The substantially equal amount of adjustment may be equal to, for example, a low-end operating period T_{OP-LE} (e.g., approximately 12.8 microseconds). Therefore, the active state period T_{ACTIVE} may be characterized by one or more inverter cycles and may be adjusted by adjusting the number of inverter cycles per active state period T_{ACTIVE}. As such, the average magnitude I_{AVE} of the load current I_{LOAD} may be adjusted by a predetermined amount (e.g., starting at time t₁ shown in FIG. 10) that corresponds, for example, to a change in load current I_{LOAD} due to an increase or decrease of the number of inverter cycles per active state period T_{ACTIVE}.

One or more burst mode periods T_{BURST} of the load regulation circuit may be characterized by active state periods T_{ACTIVE} that comprise the same number of inverter cycles. In the example of FIG. 10, three burst mode periods T_{BURST} 1002, 1004, 1006 may be characterized by equivalent active state periods T_{ACTIVE1} (e.g., active state periods T_{ACTIVE1} that have the same number of inverter cycles) and equivalent inactive state periods T_{INACTIVE1}. The active state period T_{ACTIVE2} of the burst mode period T_{BURST} 1008 may be larger than the active state periods T_{ACTIVE1} of the other burst mode periods T_{BURST} 1002, 1004, 1006 (e.g., by an additional inverter cycle). The inactive state period T_{INACTIVE2} of the burst mode period T_{BURST} 1008 may be smaller than the inactive state period T_{INACTIVE1} (e.g., by one fewer inverter cycle). In other words, the active state period T_{ACTIVE2} during the burst mode period T_{BURST} 1008 may be increased (e.g., by an additional inverter cycle) as compared to the active state periods T_{ACTIVE1} during the burst mode periods T_{BURST} 1002, 1004, 1006. The inactive state period T_{ACTIVE2} during the burst mode period T_{BURST} 1008 may be decreased (e.g., by one fewer inverter cycle) as compared to the inactive state periods T_{ACTIVE1} during the burst mode periods T_{BURST} 1002, 1004, 1006. The larger active state period T_{ACTIVE2} and smaller inactive state period T_{INACTIVE2} may result in a larger duty cycle and a corresponding larger average magnitude I_{AVE} of the load current I_{LOAD} (e.g., as shown during burst mode period 1008). The amount of increase in the average magnitude I_{AVE} of the load current I_{LOAD} may be in accordance with the additional length (e.g., in terms of inverter cycles) of the active state period T_{ACTIVE2} during the burst mode period T_{BURST} 1008. Therefore, the control circuit may adjust (e.g., increase or decrease) the average magnitude I_{AVE} of the load current I_{LOAD} by adjusting the active state period T_{ACTIVE} (e.g., by increments or decrements of one or more inverter cycles).

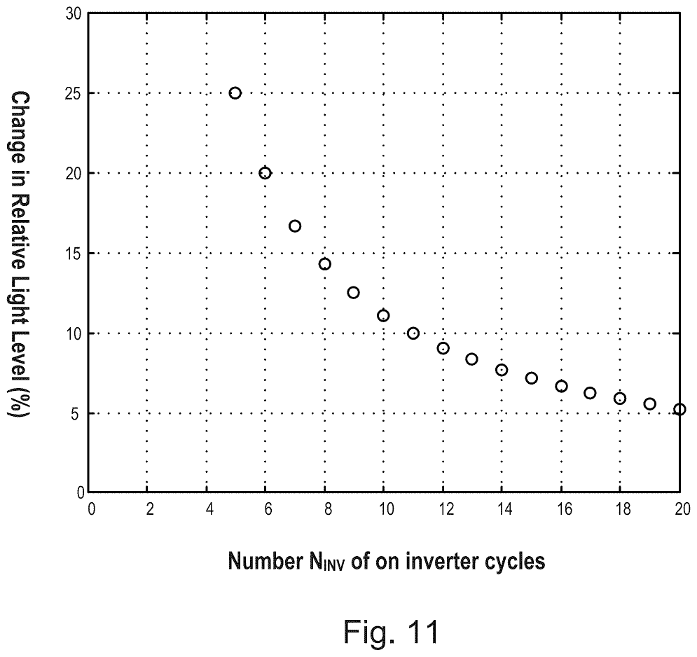

A user's eyes may be more sensitive to changes in the relative light level at lower light intensities (e.g., closer to the low-end intensity L_{LE} or when operating in the burst mode). FIG. 11 illustrates how the relative average light level of a lighting load may change as a function of the number N_{INV} of inverter cycles included in the active state period T_{ACTIVE}. As described herein, T_{ACTIVE} may be expressed as T_{ACTIVE}=N_{INV}·T_{OP-LE}, wherein T_{OP-LE} may represent a low-end operating period of the inverter circuit. As shown in FIG. 11, if the control circuit adjusts the length of the active state period T_{ACTIVE} from four to five inverter cycles, the relative light level may change by approximately 25%. If the control circuit adjusts the length of the active state period T_{ACTIVE} from five to six inverter cycles, the relative light level may change by approximately 20%. The control circuit may be configured to adjust the light intensity of the lighting load with fine granularity when the target intensity L_{TRGT} is close to the low-end intensity L_{LE}. Examples of a load control device capable of fine-tuning the light intensity of a lighting load in a low-end intensity range are described in greater detail in commonly-assigned U.S. Pat. No. 9,247,608, issued Jan. 26, 2016, and U.S. patent application Ser. No. 15/142,876, filed Apr. 29, 2016, both titled LOAD CONTROL DEVICE FOR A LIGHT-EMITTING DIODE LIGHT SOURCE, the entire disclosures of which are hereby incorporated by reference in their entireties.

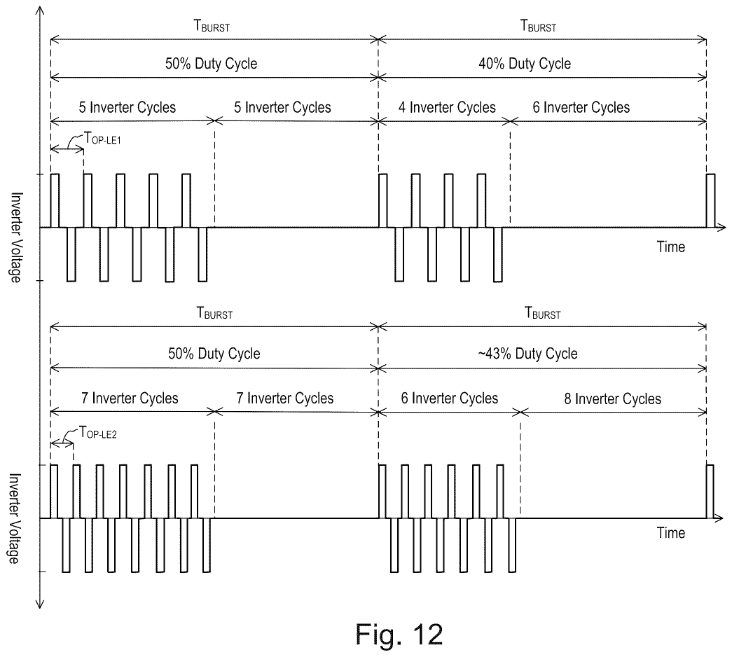

When the target intensity L_{TRGT} is close to the low-end of the light intensity range, the inverter circuit may be controlled to operate at an adjusted low-end operating frequency f_{OP-LE-ADJ} (or with an adjusted low-end operating period T_{OP-LE-ADJ}). An example effect of applying such control may be illustrated by FIG. 12. As shown, when the inverter circuit is operating at a lower frequency f_{OP-LE1} (e.g., corresponding to a longer low-end operating period T_{OP-LE1}), adjusting the length of the active state periods by one inverter cycle while keeping the burst operating period unchanged may cause the burst duty cycle to change between 50% and 40% (thus causing the light intensity of the lighting load to change accordingly). When the inverter circuit is operating at a higher frequency f_{OP-LE2} (e.g., corresponding to a shorter low-end operating period T_{OP-LE2}), adjusting the length of the active state periods by one inverter cycle while keeping the burst operating period unchanged may cause the burst duty cycle to change between 50% and 43%. In other words, as the operating frequency of the inverter circuit increases, the ability of the control circuit to fine-tune the intensity of the lighting load may increase accordingly. Therefore, when the control circuit is operating in the burst mode and/or when the target intensity L_{TRGT} of the lighting load is near the low-end of its intensity range (e.g., near the low-end transition intensity L_{TRAN}, which may be approximately 5%), the control circuit may adjust the low-end operating frequency of the inverter circuit f_{OP-LE} to an adjusted value (e.g., a higher value) such that fine-tuning of the intensity of the lighting load may be achieved, among other goals.

The operating frequency f_{OP-LE} of the inverter circuit near the low-end intensity (e.g., whether or not the inverter circuit is controlled to operate in the burst mode) may be adjusted based on a minimum on time of the inverter circuit. As described herein, during the active state of the burst mode, the control circuit may be configured to adjust the on-time T_{ON} of the drive control signals V_{DRIVE1}, V_{DRIVE2} to control the peak magnitude I_{PK} of the load current I_{LOAD} to the minimum rated current I_{MIN} using closed loop control (e.g., in response to the load current feedback signal V_{I-LOAD}). The value of the low-end operating frequency may be chosen to ensure that the control circuit does not adjust the on-time T_{ON} of the drive control signals V_{DRIVE1}, V_{DRIVE2} below the minimum on-time T_{ON-MIN}. For example, the low-end operating frequency for may be calculated by assuming worst-case operating conditions and component tolerances and stored in memory in the LED driver. Since the LED driver may be configured to drive a plurality of different LED light sources (e.g., manufactured by a plurality of different manufacturers) and/or adjust the magnitude of the load current I_{LOAD} and the magnitude of the load voltage V_{LOAD} to a plurality of different magnitudes, the value of the on-time T_{ON} during the active state of the burst mode may be greater than the minimum on-time T_{ON-MIN} for many installations. If the value of the on-time T_{ON} near the low-end intensity (e.g., during the active state of the burst mode) is too large, steps in the intensity of the LED light source may be visible to a user when the target intensity L_{TRGT} is adjusted near the low-end intensity (e.g., during the burst mode).

Accordingly, when operating near the low-end intensity (e.g., in the burst mode), the control circuit may be configured to minimize the on-time T_{ON} of the drive control signals V_{DRIVE1}, V_{DRIVE2} until the minimum on-time T_{ON-MIN} is achieved. For example, the control circuit may be configured to periodically adjust the low-end operating period T_{OP-LE} (e.g., decreasing the low-end operating period T_{OP-LE} or increasing the low-end operating frequency f_{OP-LE}) while maintaining the duty cycle of the inverter circuit constant, until the on-time T_{ON} of the drive control signals V_{DRIVE1}, V_{DRIVE2} is equal to or slightly below the minimum on-time T_{ON-MIN}. The control circuit may be configured to store the adjusted low-end operating period T_{OP-LE-ADJ} and/or the adjusted low-end operating frequency f_{OP-LE-ADJ} in memory. Subsequently, the adjusted low-end operating period T_{OP-LE-ADJ} and/or the adjusted low-end operating frequency f_{OP-LE-ADJ} may be used as the low-end operating period T_{OP-LE} and/or low-end operating frequency f_{OP-LE} when the target intensity L_{TRGT} is close to the low-end of the light intensity range (e.g., during burst mode). The stored adjusted low-end operating period T_{OP-LE} and/or adjusted low-end operating frequency f_{OP-LE-ADJ} may also be used during the normal mode. For example, during the normal mode, the control circuit may adjust the operating frequency f_{OP} of the inverter circuit between the adjusted low-end operating frequency f_{OP-LE-ADJ} and a high-end operating frequency f_{OP-HE}. The operating frequency f_{OP} may be adjusted as a function (e.g., as a linear function) of the target intensity L_{TRGT} according to an adjusted operating frequency plot 1300 (e.g., as shown in FIG. 13).

FIG. 13 is an example plot of the operating frequency f_{OP} of the inverter circuit as a function of the target intensity L_{TRGT}. As shown, the low-end operating frequency of the inverter circuit may be controlled from a default low-end operating frequency towards an adjusted low-end operating frequency f_{OP-LE-ADJ} (e.g., approximately 58 kHz) when the target intensity L_{TRGT} is near or below a low-end transition value L_{TRAN-LOW} and/or when the target load current is near or below a low-end transition value I_{TRAN-LOW}. The low-end transition intensity L_{TRAN-LOW} may or may not be the same as the low-end transition intensity L_{TRAN} described herein. For example, the low-end transition intensity L_{TRAN-LOW} may be greater than the low-end transition intensity L_{TRAN}. Similarly, the low-end transition current I_{TRAN-LOW} may or may not be the same as the minimum rated current I_{MIN} described herein. For example, the low-end transition current I_{TRAN-LOW} may be greater than the minimum rated current I_{MIN}. The operating frequency of the inverter circuit may be adjusted (e.g., decreased linearly) as the target intensity L_{TRGT} (or target load current I_{TRGT}) is adjusted towards the high-end intensity L_{HE} (or the maximum rated current I_{MAX}). The operating frequency may be adjusted to a high-end operating frequency f_{OP-HE} (e.g., approximately 32 kHz) when the target intensity L_{TRGT} reaches a high-end transition value L_{TRAN-HIGH} (or when the target load current I_{TRGT} reaches a high-end transition value I_{TRAN-HIGH}). The high-end transition value for the target intensity may be less than or equal to the maximum intensity L_{HE} (e.g., 100%) of the lighting load. The high-end transition value for the target load current may be less than or equal to the maximum rated current I_{MAX} of the lighting load.

As the target intensity L_{TRGT} is controlled between the high-end intensity L_{HE} of the lighting load, the operating frequency for of the inverter circuit may be adjusted (e.g., gradually decreased) towards the high-end operating frequency f_{OP-HE}. The operating period of the inverter circuit may be adjusted (e.g., gradually increased) accordingly. The adjustment to the operating frequency may be performed as a function of the target intensity L_{TRGT} (or the target load current I_{TRGT}). For example, as the target intensity L_{TRGT} or target load current I_{TRGT} increases, the operating frequency of the inverter circuit may be decreased proportionally (e.g., as a linear function of the target intensity L_{TRGT} or the target load current I_{TRGT}). The operating frequency may reach the high-end operating frequency f_{OP-HE} once the target intensity L_{TRGT} or target load current I_{TRGT} reaches the high-end transition values described herein. The high-end transition value(s) may be predetermined (e.g., determined during system configuration and stored in memory). For example, the high-end transition value(s) may correspond to the maximum intensity (e.g., 100%) or the maximum rated current of the lighting load. Alternatively, the high-end transition value(s) may be set to be less than the maximum intensity (e.g., to 90%) or less than the maximum rated current of the lighting load.

Although the example plot in FIG. 13 shows that the operating frequency for is adjusted to and maintained at the adjusted low-end operating frequency f_{OP-LE-ADJ} when the target intensity L_{TRGT} is equal to or less than the low-end transition value L_{TRAN-LOW}, the scope of the present disclosure is not limited to only such an implementation. In certain embodiments, the control circuit may be configured to continue to adjust the low-end operating frequency after the target intensity L_{TRGT} is adjusted below the low-end transition value L_{TRAN-LOW}. For example, the control circuit may be configured to adjust the low-end operating frequency as a function (e.g., a linear function) of the target intensity L_{TRGT} even when the target intensity L_{TRGT} is adjusted below the low-end transition value L_{TRAN-LOW}. In other words, the control circuit may be configured to adjust the operating frequency of the inverter circuit as a function (e.g., a linear function) of the target intensity L_{TRGT} so long as the target intensity L_{TRGT} is less than the high-end transition value L_{TRAN-HIGH}. Further, although the example plot in FIG. 13 shows that the adjusted low-end operating frequency f_{OP-LE-ADJ} is higher than the high-end operating frequency f_{OP-HE}, the reverse may be true in some embodiments. In other words, the adjusted low-end operating frequency f_{OP-LE-ADJ} may be lower than the high-end operating frequency f_{OP-HE} in some embodiments, and the control circuit may be configured to increase the operating frequency of the inverter circuit as the target intensity L_{TRGT} is adjusted from the low-end transition value L_{TRAN-LOW} to the high-end transition value L_{TRAN-HIGH}.

FIG. 14 shows example plots illustrating the operation of a control circuit and an inverter circuit of an LED driver (e.g., the control circuit 150 and the inverter circuit of the forward converter 240), for example during the burst mode, to minimize the on-time T_{ON} of the drive control signals V_{DRIVE1}, V_{DRIVE2} until the minimum on time T_{ON-MIN} is achieved. The target intensity L_{TRGT} may be adjusted in response to digital messages received via a communication circuit (e.g., the communication circuit 180). After the target intensity L_{TRGT} is controlled below the transition intensity L_{TRAN} (e.g., at time t₁ of FIG. 14 and/or when the control circuit begins to operate the inverter circuit in the burst mode), the on-time T_{ON} may be greater than the minimum on-time T_{ON-MIN}. The control circuit may decrease the low-end operating period T_{OP-LE} (e.g., at time t₂) by a predetermined amount ΔT_{OP} (and thus increase the low-end operating frequency f_{OP-LE}). The control circuit may decrease the low-end operating period T_{OP-LE} while maintaining the duty cycle of the inverter circuit constant. The predetermined amount ΔT_{OP} may be approximately 42 nanoseconds, for example. The control circuit may then determine whether the on-time T_{ON} is less than or equal to the minimum on-time T_{ON-MIN}. In an example, the control circuit may wait for a wait period T_{WAIT} (e.g., approximately ten seconds) before checking to determine if the on-time T_{ON} is less than or equal to the minimum on-time T_{ON-MIN} (e.g., at time t₃). If the on-time T_{ON} is still greater than the minimum on-time T_{ON-MIN} at time t₃, the control circuit may once again decrease the low-end operating period T_{OP-LE} by the predetermined amount ΔT_{OP} (e.g., at time t₃). As shown in FIG. 14, after this decrease in the low-end operating period T_{OP-LE}, the on-time T_{ON} may decrease below the minimum on-time T_{ON-MIN}. As described herein, the value of the minimum on-time T_{ON-MIN} may be predetermined (e.g., set during configuration and stored in memory) such that the on time of the inverter circuit may be maintained within the hardware limits of the relevant circuitry. Once the on-time T_{ON} is decreased to or below the minimum on-time T_{ON-MIN}, the control circuit may cease reducing the low-end operating period T_{OP-LE}. The control circuit may store the final, adjusted value for the low-end operating period T_{OP-LE} (and/or the final, adjusted value for the low-end operating frequency f_{OP-LE}) in memory.

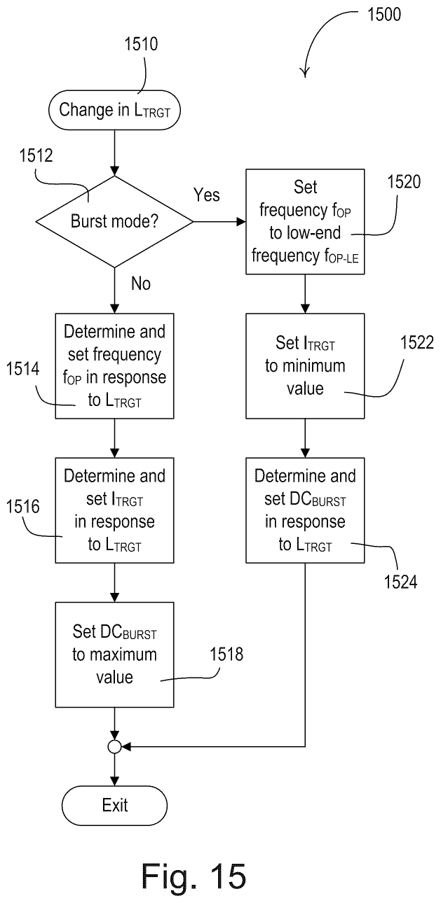

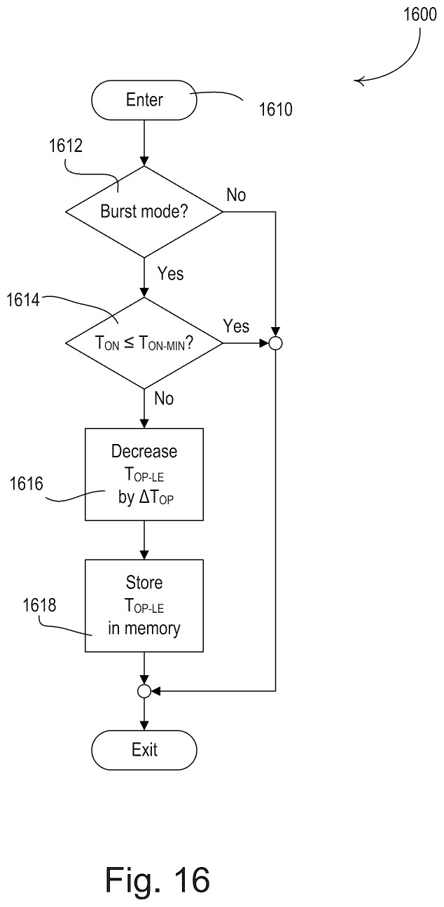

FIGS. 15 and 16 are simplified flowcharts of example procedures that may be executed by a control circuit of a load control device (e.g., the control circuit 150 of the LED driver 100 shown in FIG. 1 and/or the control circuit 150 controlling the forward converter 240 and the current sense circuit 260 shown in FIG. 5). FIG. 15 is a simplified flowchart of an example target intensity procedure 1500 that may be executed by the control circuit, e.g., when the target intensity L_{TRGT} is adjusted at 1510 (e.g., in response to digital messages received via the communication circuit 180). The control circuit may determine if it is operating the forward converter near or below the transition intensity L_{TRAN-LOW} (or L_{TRGT}<L_{TRAN-LOW}) and/or in the burst mode at 1512. If the control circuit determines that it is not operating the forward converter below the transition intensity L_{TRAN-LOW} or in the burst mode (e.g., but rather in the normal mode), then the control circuit may determine and set the operating frequency for as a function of the target intensity L_{TRGT} at 1514 (e.g., as shown in FIG. 13). The control circuit may then determine and set the target load current I_{TRGT} as a function of the target intensity L_{TRGT} at 1516 (e.g., as shown in FIG. 2), and/or set the burst duty cycle DC_{BURST} equal to a maximum duty cycle DC_{MAX} (e.g., approximately 100%) at 1518 (e.g., as shown in FIG. 3), before the target intensity procedure 1500 exits.

If the control circuit determines that it is operating the forward converter in the burst mode and/or that the target intensity L_{TRGT} is near or below the transition intensity L_{TRAN-LOW} (e.g., L_{TRGT}<L_{TRAN-LOW}), then the control circuit may set the operating frequency f_{OP} to the low-end operating frequency f_{OP-LE} at step 1520 and may set the target load current I_{TRGT} to a minimum value (e.g., to the minimum rated current I_{MIN}) at 1522 (e.g., as shown in FIG. 2). The control circuit may then determine and set the burst duty cycle DC_{BURST} (if the control circuit is operating in the burst mode) as a function of the target intensity L_{TRGT} at 1524 (e.g., using open loop control as shown in FIG. 3), and the control circuit may exit the target intensity procedure 1500.

FIG. 16 is a simplified flowchart of an example low-end period adjustment procedure 1600 that may be executed by the control circuit (e.g., periodically at every ten seconds) at 1610. If the target intensity L_{TRGT} is below the transition intensity L_{TRAN-LOW} and/or the control circuit is operating in the burst mode at 1612, the control circuit may determine if the present value for the on-time T_{ON} is less than or equal to the minimum on-time T_{ON-MIN} (e.g., approximately 500 microseconds) at 1614. If not, the control circuit may decrease the low-end operating period T_{OP-LE} by a predetermined amount ΔT_{OP} at 1616 (e.g., while holding the duty cycle of the inverter circuit constant) and store the new value for the low-end operating period T_{OP-LE} in memory at 1618, before the example low-end period adjustment procedure 1600 exits. The control circuit may continue to periodically execute the example low-end period adjustment procedure 1600 (e.g., at every ten seconds) to decrease the low-end operating period T_{OP-LE} by the predetermined amount ΔT_{OP} at 1616 until the on-time T_{ON} is determined to be less than or equal to the minimum on-time T_{ON-MIN} at 1614.

The control circuit may adjust the low-end operating period T_{OP-LE} using the low-end period adjustment procedure 1600 in addition to providing fine-tune adjustment of the intensity of the lighting load. For example, the control circuit may be configured to operate in the burst mode when the target intensity L_{TRGT} is below the transition intensity L_{TRAN} and adjust the lengths of the active state period T_{ACTIVE} and/or the inactive state period T_{INACTIVE} at the adjusted low-end operating frequency in order to fine-tune the intensity of the lighting load. Although the disclosure herein describes the low-end operating period adjustment procedure 1600 in the context of burst mode, the procedure may be executed even if the control circuit is not configured to operate in the burst mode.

One or more of the embodiments described herein (e.g., as performed by a load control device) may be used to decrease the intensity of a lighting load and/or increase the intensity of the lighting load. For example, one or more embodiments described herein may be used to adjust the intensity of the lighting load from on to off, from off to on, from a higher intensity to a lower intensity, and/or from a lower intensity to a higher intensity. For example, one or more of the embodiments described herein (e.g., as performed by a load control device) may be used to fade the intensity of a light source from on to off (e.g., the low-end intensity L_{LE} may be equal to 0%) and/or to fade the intensity of the light source from off to on.

Although described with reference to an LED driver, one or more embodiments described herein may be used with other load control devices. For example, one or more of the embodiments described herein may be performed by a variety of load control devices that are configured to control of a variety of electrical load types, such as, for example, an LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, a controllable circuit breaker, or other switching device for turning electrical loads or appliances on and off; a plug-in load control device, a controllable electrical receptacle, or a controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or a computer monitor; a power supply; an audio system or an amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

1. A light-emitting diode (LED) lighting control apparatus, comprising:
load regulation circuitry to generate a load current output between a minimum load current value and a maximum load current value;
LED driver control circuitry operatively coupled to the load regulation circuitry, the LED driver control circuitry to:
receive a target intensity;
determine a target load current based on the received load target intensity;
determine whether the target load current is less than the minimum load current value; and
responsive to the determination that the target load current is less than the minimum load current value:
cause the load regulation circuitry to output the minimum load current;
cause the load regulation circuitry to enter a BURST operating mode in which the load regulation circuitry operates at a variable duty cycle by alternating the load current output between an ACTIVE state and an INACTIVE state;
wherein, in the ACTIVE state, the load regulation circuitry produces a load current output at the minimum load current value; and
wherein, in the INACTIVE state, the load regulation circuitry does not produce a load current output.

2. The LED lighting control apparatus of claim 1 wherein the LED driver control circuitry to further:
responsive to the determination that the target load current is at or above the minimum load current value:
cause the load regulation circuitry to operate in a NORMAL operating mode at a fixed duty cycle; and
vary the load regulation circuitry current output to provide the target load current.

3. The LED lighting control apparatus of claim 2, wherein to cause the load regulation circuitry to operate in the NORMAL operating mode at the fixed duty cycle, the LED driver control circuitry to further:
cause the load regulation circuitry to operate in a NORMAL operating mode at a 100% duty cycle.

4. The LED lighting control apparatus of claim 1, wherein to cause the load regulation circuitry to enter a BURST operating mode in which the load regulation circuitry operates at a variable duty cycle by alternating the load current output between an ACTIVE state and an INACTIVE state, the LED driver control circuitry to further:
cause the load regulation circuitry to periodically decrease the ACTIVE state duration by a predetermined amount until the ACTIVE state duration is less than or equal to a minimum on time.

5. The LED lighting control apparatus of claim 1 wherein to determine the target load current based on the received target intensity, the LED control circuitry to further:
retrieve data indicative of a relationship between output intensity and load current associated with an operatively coupled LED fixture from operatively coupled memory circuitry; and
determine the target load current using the retrieved data indicative of the relationship between LED fixture intensity and load current.

6. The LED lighting control apparatus of claim 5, wherein to determine whether the target load current is less than the minimum load current value, the LED control circuitry to further:
retrieve data indicative of a minimum load current associated with the operatively coupled LED fixture from the operatively coupled memory circuitry; and
determine whether the target load current is less than the minimum load current associated with the operatively coupled LED fixture.

7. A light-emitting diode (LED) lighting control method, comprising:
receiving by light-emitting diode (LED) driver control circuitry, an input that includes information indicative of a target output intensity of an LED fixture;
determining by the LED driver control circuitry, a target load current of the LED fixture based on the received target output intensity of the LED fixture;
determining by the LED driver control circuitry, whether the target load current of the LED fixture is less than the minimum load current of the LED fixture; and
responsive to the determination that the target load current is less than the minimum load current value:
causing by the LED driver control circuitry, the load regulation circuitry to output the minimum load current;
causing by the LED driver control circuitry, the load regulation circuitry to enter a BURST operating mode in which the load regulation circuitry operates at a variable duty cycle by alternating the load current output between an ACTIVE state and an INACTIVE state;
wherein, in the ACTIVE state, the load regulation circuitry produces a load current output at the minimum load current value; and
wherein, in the INACTIVE state, the load regulation circuitry does not produce a load current output.

8. The LED lighting method of claim 7, further comprising, responsive to the determination that the target load current is at or above the minimum load current value:
causing by the LED driver control circuitry, the load regulation circuitry to operate in a NORMAL operating mode at a fixed duty cycle; and
varying by the LED driver control circuitry, the load regulation circuitry current output to provide the target load current.

9. The LED lighting method of claim 8, wherein causing the load regulation circuitry to operate in the NORMAL operating mode at the fixed duty cycle, further comprises:
causing by the LED driver control circuitry, the load regulation circuitry to operate in a NORMAL operating mode at a 100% duty cycle.

10. The LED lighting method of claim 7, wherein causing the load regulation circuitry to enter a BURST operating mode in which the load regulation circuitry operates at a variable duty cycle by alternating the load current output between an ACTIVE state and an INACTIVE state, further comprises:
causing by the LED driver control circuitry, the load regulation circuitry to periodically decrease the ACTIVE state duration by a predetermined amount until the ACTIVE state duration is less than or equal to a minimum on time.

11. The LED lighting method of claim 7, wherein determining the target load current based on the received target intensity, further comprises:
retrieving by the LED driver control circuitry, data indicative of a relationship between output intensity and load current associated with an operatively coupled LED fixture from operatively coupled memory circuitry; and
determining by the LED driver control circuitry, the target load current using the retrieved data indicative of the relationship between LED fixture intensity and load current.

12. The LED lighting method of claim 11, wherein determining whether the target load current is less than the minimum load current value, further comprises:
retrieving by the LED driver control circuitry, data indicative of a minimum load current associated with the operatively coupled LED fixture from the operatively coupled memory circuitry; and
determining by the LED driver control circuitry, whether the target load current is less than the minimum load current associated with the operatively coupled LED fixture.

13. A non-transitory, machine-readable, storage device that includes instructions that, when executed by light-emitting diode (LED) driver control circuitry, cause the LED driver control circuitry to:
receive an input that includes information indicative of a target output intensity of an LED fixture;
determine a target load current of the LED fixture based on the received target output intensity of the LED fixture;
determine whether the target load current of the LED fixture is less than the minimum load current of the LED fixture; and
responsive to the determination that the target load current is less than the minimum load current value:
cause the load regulation circuitry to output the minimum load current;
cause the load regulation circuitry to enter a BURST operating mode in which the load regulation circuitry operates at a variable duty cycle by alternating the load current output between an ACTIVE state and an INACTIVE state;
wherein, in the ACTIVE state, the load regulation circuitry produces a load current output at the minimum load current value; and
wherein, in the INACTIVE state, the load regulation circuitry does not produce a load current output.

14. The non-transitory, machine-readable, storage device of claim 13 wherein the instructions, when executed by the LED driver control circuitry, further cause the LED driver control circuitry to:
cause the load regulation circuitry to operate in a NORMAL operating mode at a fixed duty cycle; and
adjust the load regulation circuitry current output to provide the target load current.

15. The non-transitory, machine-readable, storage device of claim 14 wherein the instructions that cause the LED driver control circuitry to cause the load regulation circuitry to operate in the NORMAL operating mode at the fixed duty cycle, further cause the LED driver control circuitry to:
cause the load regulation circuitry to operate in a NORMAL operating mode at a 100% duty cycle.

16. The non-transitory, machine-readable, storage device of claim 13 wherein the instructions that cause the LED driver control circuitry to cause the load regulation circuitry to enter a BURST operating mode in which the load regulation circuitry operates at a variable duty cycle by alternating the load current output between an ACTIVE state and an INACTIVE state, further comprises:
cause the load regulation circuitry to periodically decrease the ACTIVE state duration by a predetermined amount until the ACTIVE state duration is less than or equal to a minimum on time.

17. The non-transitory, machine-readable, storage device of claim 13 wherein the instructions that cause the LED driver control circuitry to determine the target load current based on the received target intensity, further cause the LED driver control circuitry to:
retrieve data indicative of a relationship between output intensity and load current associated with an operatively coupled LED fixture from operatively coupled memory circuitry; and
determine the target load current using the retrieved data indicative of the relationship between LED fixture intensity and load current.

18. The non-transitory, machine-readable, storage device of claim 13 wherein the instructions that cause the LED driver control circuitry to determine whether the target load current is less than the minimum load current value, further cause the LED driver control circuitry to:
retrieve data indicative of a minimum load current associated with the operatively coupled LED fixture from the operatively coupled memory circuitry; and
determine whether the target load current is less than the minimum load current associated with the operatively coupled LED fixture.
